(19) United States
(12) Patent Application Publication
(10) Pub. No.: US 2018/0121172 A1
(43) Pub. Date: May 3, 2018

(54) SPECIFYING MODELS OF AN ARCHITECTURAL TYPE

(71) Applicant: HEWLETT PACKARD ENTERPRISE DEVELOPMENT LP, Tysons, VA (US)

(72) Inventors: Steve MARNEY, Pontiac, MI (US); Aric ROHNER, Asheville, NC (US); Joe HILL, Austin, TX (US)

(73) Assignee: HEWLETT PACKARD ENTERPRISE DEVELOPMENT LP, Tysons, VA (US)

(21) Appl. No.: 15/537,868

(22) PCT Filed: Dec. 19, 2014
(86) PCT No.: PCT/US2014/071380

§ 371 Date: Jun. 19, 2017

(51) Int. Cl. G06F 8/20; G06F 8/35; G06F 9/445; G06Q 10/06

(52) U.S. Cl. CPC G06F 8/20; G06Q 10/067; G06F 8/64; G06F 8/35

(57) ABSTRACT

Example implementations relate to specifying models of an architectural type. In an example implementation, a domain model of the architectural type is captured and a meta-language for the architectural type is defined. A platform-independent representation of the domain model may be exported. The platform-independent representation of the domain model may be transformed into a platform-specific representation of the domain model that is executable on a targeted runtime platform.

### BACKGROUND

Businesses may increase profits by maximizing quality while at the same time minimizing cost, risk, time-to-market, and time-to-deliver. When developing solutions for customers, businesses may consider factors such as multiple tenants, client security systems, suppliers, geographies, and delivery models.

### BRIEF DESCRIPTION OF THE DRAWINGS

FIG. 1 is a high-level diagram of an example computer system which may be implemented for specifying models of an architectural type.

FIG. 2 is a block diagram of an example architecture methodology which may be implemented for specifying models of an architectural type.

FIG. 3 is a block diagram of an example modeling language for specifying models of an architectural type.

FIG. 4 is a block diagram of an example runtime platform for executing models of an architectural type.

FIG. 5 is an illustration showing operation of an example tool chain for service design to execution which may be implemented for specifying models of an architectural type.

FIG. 5A illustrates an example system to specify models of an architectural type.

FIG. 5B illustrates an example computer program product 504 to specify models of an architectural type.

FIGS. 6, 6A, and 7 are flowcharts illustrating example operations which may be implemented for specifying models of an architectural type.

### DETAILED DESCRIPTION

Businesses constantly face the need to increase profits by maximizing quality while at the same time minimizing cost, risk, time-to-market, and time-to-deliver. Meeting these needs has become especially challenging because of the complexities that must be addressed. These complexities include multiple tenants, client security systems, suppliers, geographies, and delivery models. In addition, solutions have to function together to handle: (a) the complexities of individual solutions; (b) those that arise from interacting information sources and destinations each with their own data representations; (c) composite user interfaces; and (d) variations of system interface protocols (e.g., web services, language-specific APIs, extract/transform/load, real-time, batch). Further, challenges include the need for agility, scalability, and availability. Failure to address these challenges can result in multiple failures in development projects, client contracts, and service line offerings and portfolios.

Management of the design, build, and run of composite, role-based, service-enabled user experiences is complicated. This issue is exacerbated when considering the full range of edge device options in use today, such as web, mobile, and fat client applications. Current approaches rely heavily on manual processes which can cause multiple problems, such as failures to realize opportunities for re-use, delays in producing executable code once designs are complete, and inconsistencies of the patterns used to implement and deploy user interface code. In addition to these issues, current approaches make changing user interface solutions difficult. These problems negatively impact the technical quality and business value of user experience solutions, and result in poorer user interfaces that reduce the productivity and degrade the overall experiences of end users.

A model-driven tool chain is disclosed that connects business architecture to the design of services and to executable composite services. By standardizing design patterns and automating configuration generation, the systems and methods disclosed herein enable service providers to focus on the value-creating aspects unique to the end-user domain.

More generally, systems and methods are disclosed herein for pattern-based, model-driven tool chains that eliminate the manual build phase for any solution space to which they are applied. The systems and methods significantly reduce cost and implementation time, and dramatically increase quality of the product. This integrated solution represents the basis for broad sweeping industry reformations.

In an example, a method includes capturing domain model of the architectural type. The example method also includes exporting a platform-independent representation of the domain model. The example method also includes transforming the platform-independent representation of the domain model into a targeted runtime platform.

In an example, a system includes a data capture tool to define a domain model of the architectural type and export a platform-independent representation of the domain model. The data capture tool may define a user interface (UI) meta-language for the architectural type. The data capture tool may also identify object types and relationship types for the architectural type. The example system also includes a transformation tool to transform the platform-independent representation of the domain model into a targeted runtime platform. The transformation tool may also link separate meta-languages between different architectural types to generate a meta-system. The system may also include a custom code implementation of a composite service framework runtime platform to execute the platform-independent representation of the domain model.

In an example, a computer program product is embodied as computer-readable instructions stored on a non-transient computer-readable media and executable by a processor to determine a domain model of an architectural type, and transform a platform-independent representation of the domain model into a targeted runtime platform specifying models of the architectural type.

In an example, the architectural type may be selected from Business Contextual Architecture (BCA), Conceptual Service Architecture (CSA), Logical Design Architecture (LDA), Physical Technology Architecture (PTA), Workflow Architecture, User Experience Architecture, and Orchestration Architecture. Other architectural types are also contemplated. Also in an example, the platform-independent representation of the domain model may be an XML representation.

It can be seen that the systems and methods disclosed herein implement a design-to-execution tool chain for service integration, following a model-driven meta-pattern, which defines a platform-independent design, from which platform-specific implementations can be generated. The systems and methods are transformative to the application design and development space.

Before continuing, it is noted that as used herein, the terms “includes” and “including” mean, but are not limited to, “includes” or “including” and “includes at least” or “including at least,” The term “based on” means “based on” and “based at least in part on.”

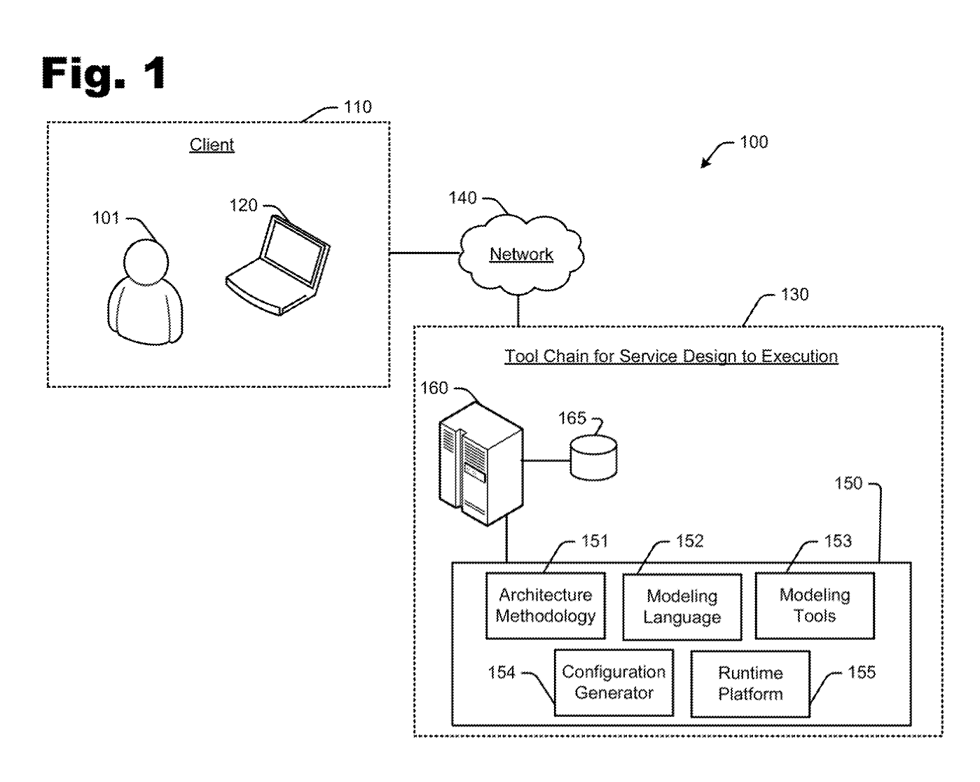

FIG. 1 is a high-level diagram of an example computer system 100 which may be implemented for specifying models of an architectural type. System 100 may be implemented with any of a wide variety of computing devices, such as, but not limited to, stand-alone computers and computer servers, to name only a few examples. Each of the computing devices may include memory, storage, and a degree of data processing capability at least sufficient to manage a communications connection either directly with one another or indirectly (e.g., via a network). At least one of the computing devices is also configured with sufficient processing capability to execute the program code described herein.

In an example, the system 100 may include a client interface 110 for a user 101 at client computing device 120 to access a tool chain 130 for service design to execution. It is noted that the client interface 110 may access the tool chain 130 via a network 140, or may be directly connected. In addition, the computing devices of the client interface 110 and the tool chain 130 are not limited to any particular type of devices.

Regardless of the specific configuration, the system 100 includes program code 150 to implement the tool chain 130. In an example, the program code 150 may be executed by any suitable computing device (e.g., client computing device 120 and/or server computer 160).

It is noted that the operations described herein may be executed by program code residing on any number and/or type of computing device. The components shown in FIG. 1 are provided only for purposes of illustration of an example operating environment, and are not intended to limit implementation to any particular system. In addition, it is contemplated that the execution of program code may be performed on a separate computing system (e.g., a server bank) having more processing capability than an individual computing device.

In an example, the program code 150 may be implemented as machine-readable instructions (such as but not limited to, software or firmware). The machine-readable instructions may be stored on non-transient computer readable medium 165, and are executable by one or more processor (e.g., of the server computer 160) to perform the operations described herein. The program code 150 may include application programming interfaces (APIs) and related support infrastructure to implement the operations described herein.

In an example, the program code 150 executes the function of a model-driven meta-pattern. The model-driven meta-pattern defines a platform-independent design, from which platform-specific implementations can be generated. In an example, the program code includes self-contained modules to implement a design-to-execution tool chain for service integration. These modules can be integrated within a self-standing tool, or may be implemented as agents that run on top of or interact with existing program code. In FIG. 1, the program code 150 is shown as it may include an architecture methodology module 151, a modeling language module 152, a modeling tools module 153, a configuration generator 154, and a runtime platform 155.

The architecture methodology module 151 may be executed with the modeling language module 152 to define a user interface (UI) meta-language. For example, the UI meta-language may be specified in a table utilizing a subject object and verb object, and the relationship(s) between these.

The modeling tools nodule 153 may include a data capture tool. In an example, the data capture tool may be implemented in a spreadsheet with a meta-language and data entry template. The data capture tool receives user input defining objects and roles of those objects.

The configuration generator 154 may be executed to define the user interface UI behavior using the UI meta-language and data received by the data capture tool. The configuration generator takes as input the data from the data capture tool, and based on the UI meta-language, outputs a platform-independent representation (e.g., a diagram and/or XML document) of the objects and roles of those objects.

In an example, the configuration generator 154 may implement a transformation tool. The transformation tool receives the platform-independent representation as input, and transforms the platform-independent representation into an executable for a targeted runtime platform (e.g., compiled application code, or a configuration file). The runtime platform 155 may deploy the executable in a target environment.

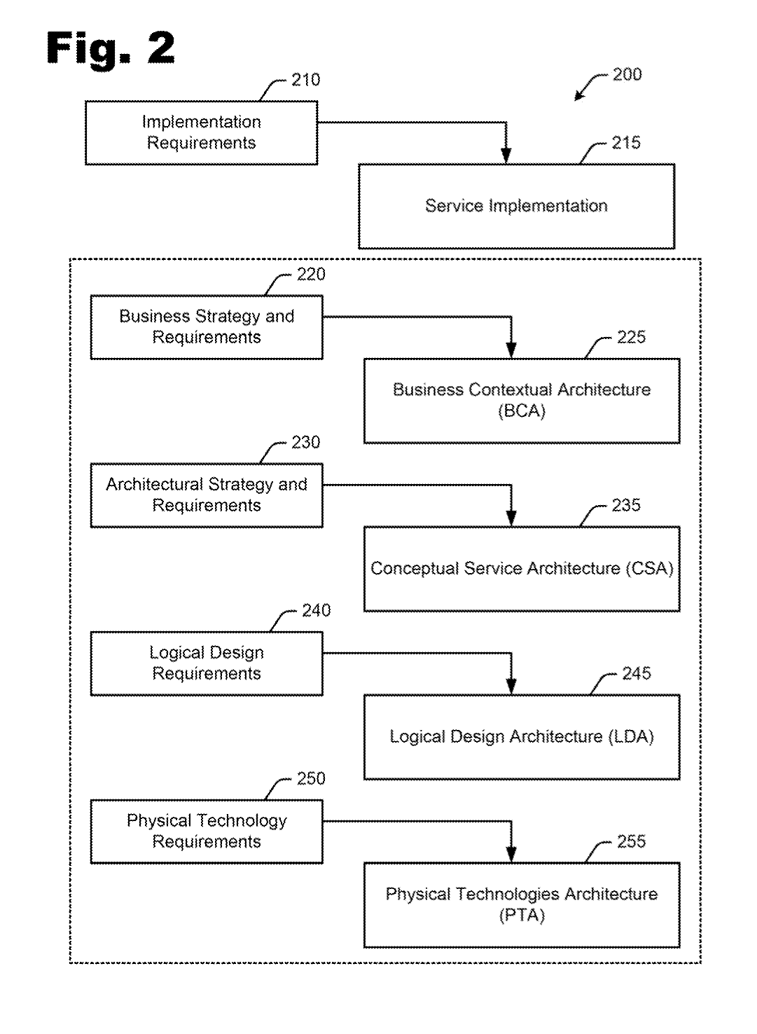

The program code described generally above can be better understood with reference to FIGS. 2-7 and the following discussion of various example functions. It is noted, however, that the operations described herein are not limited to any specific implementation with any particular type of program code.

FIG. 2 is a block diagram of an architecture methodology 200 which may be implemented for specifying models of an example architectural type. In an example, the architecture methodology 200 may be implemented as a Role-Based Domain Architecture (RDA) methodology. The RDA methodology is a formal and disciplined architecture methodology for modeling service-oriented architectures, separating the design space into layered viewpoints that are relevant to various domains of concerns.

The RDA methodology may incorporate new modeling “languages,” incorporate and synthesize standard modeling “languages” (e.g., BPEL, BPMN, XSD, XSL, and WSDL), and introduce new modeling languages, e.g., authoriZation-Based Access Control (ZBAC), User Centered Design (UCD), and the Conceptual Services Implementation Platform (CSIP). In an example, the RDA methodology includes domains 210 (e.g., the implementation requirements) and associated layers 215 for modeling the domains (e.g., service implementation).

The cloud includes services in many domains. For example, domains offered via the cloud include, but are not limited to, IT services (e.g., Virtual Private Cloud, service management, security management, workplace, hosting, and messaging & collaboration), business functions (e.g., human resources and accounting), and services offered in different industries (e.g., healthcare, travel, manufacturing, and financial services). Through integration, orchestration, workflow, and user experience, the RDA methodology provides the ability to assemble composite services from a wide array of available services, thus acting as “glue” for the cloud.

In an example, a business strategy and requirements domain 220 may be modeled according to a Business Contextual Architecture (BGA) 225. For purposes of illustration, BCA Object Types may include: Roles, Responsibilities, & Artifacts (e.g., information exchanged). Relationship Types may include: a responsibility assigned to a role, a responsibility that provides an artifact, a responsibility that consumes the artifact, and so forth.

In an example, an architectural strategy and requirements domain 230 may be modeled according to a Conceptual Services Architecture (CSA) 235. CSA Object Types may include: Conceptual Service (CS), Fundamental Object (FO), and User Interface (UI). Relationship Types may include, but are not limited to a CS that owns a FO; a CS that subscribes to a FO; a CS that depends on a CS; and a UI that depends on a CS.

In an example, a logical design requirements domain 240 may be modeled according to a Logical Design Architecture (LDA) 245. The LDA may include User Experience, Workflow, Orchestration, Schema, and so forth (see below).

In an example, a physical technology requirements 250 may be modeled according to a Physical Technologies Architecture (PTA) 255. PTA object types may include a network, server, etc. for designing deployment architectures. Relationships Types may include a network that contains a server, a server that contains an application, and so forth.

The domains and associated modeling layers are only shown in FIG. 2 for purposes of illustration of example domains and modeling layers, Other examples are also contemplated as being within the scope of the disclosure herein, as will be readily appreciated by those having ordinary skill in the art after becoming familiar with the teachings herein.

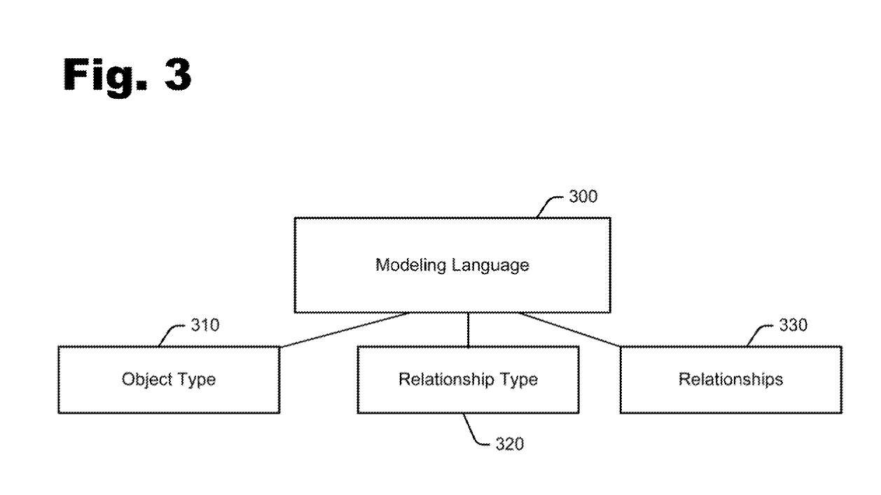

FIG. 3 is a block diagram of an example modeling language 300 for specifying models of an architectural type. In an example, the RDA methodology can be implemented as a meta-model modeling language 300 that defines specific object types 310, relationship types 320 for each model layer (e.g., the layers 225-255 in FIG. 2), and the relationships 330 between layers. This standardization makes it possible to perform automated traceability and consistency checking, and is a first step in establishing executable user-centered designs.

In an example, the methodology may include a workflow. A “workflow” is a set of tasks (manual and/or automated), and the logic and/or sequencing between the tasks. By way of example, a workflow implemented by a human resources (HR) department to promote employees may include the manager submitting a promotion request, and the manager's manager reviewing and approving the promotion request.

The methodology may also include orchestration of a collection of references to individual services and the logic by which they are collected. In the HR example, this may include creating a new case of employee promotion workflow, including the details of the employee in question, and then executing the employee promotion (after approval).

The methodology may also include implementing the user experience. The user experience may include a set of user screens and activities that link the screens for carrying out a manual task in a workflow. In the HR example, the employee's manager may utilize a manager self-service screen (e.g., to select “promote employee”), a manager select employee screen, and a confirm employee selection screen (e.g. for entering a new job code and reason for promotion).

The methodology may gather input for each of these tasks to define a domain model of the architectural type. The methodology may further define a user interface (UI) meta-language for the architectural type, identifying object types and relationship types for the architectural type. This information may then be implemented to generate an executable user-centered design.

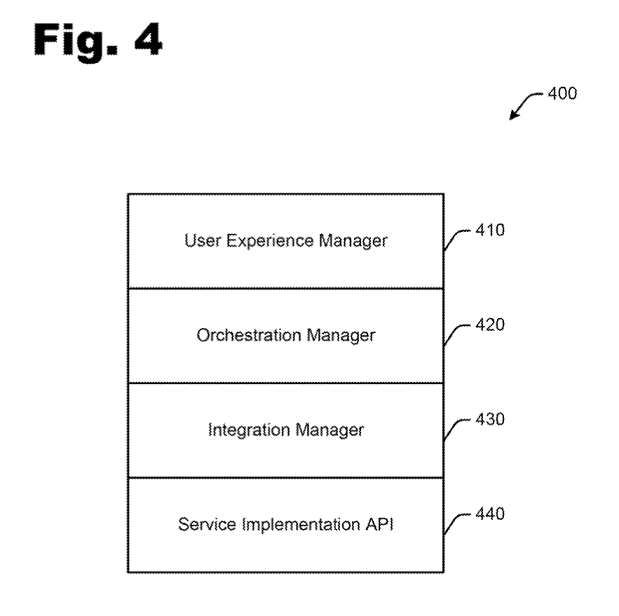

FIG. 4 is a block diagram of an example runtime platform 400 for executing models of an architectural type.

The target runtime platform 400 is a general purpose meta-system configured to deploy the executable generated to implement the multiple architectural types (i.e., user-centered design, orchestration, workflow, integration, etc.). In an example, the target runtime platform 400 is a domain-independent, configuration-driven environment designed to execute the composite service designs produced above.

By way of illustration, the runtime platform 400 may be a Service Composition Framework (SCF) Runtime Platform. The runtime platform 400 may include APIs such as a User Experience Manager 410, an Orchestration Manager 420, an Integration Manager 430, and a Service Implementation API 440. During operation, the runtime platform 400 accepts the platform-specific user-centered design to be executed by User Experience Manager 410, the platform-specific workflow and orchestration designs to be executed by the Orchestration Manager 420, and the platform-specific integration design to be executed by Integration Manager 430.

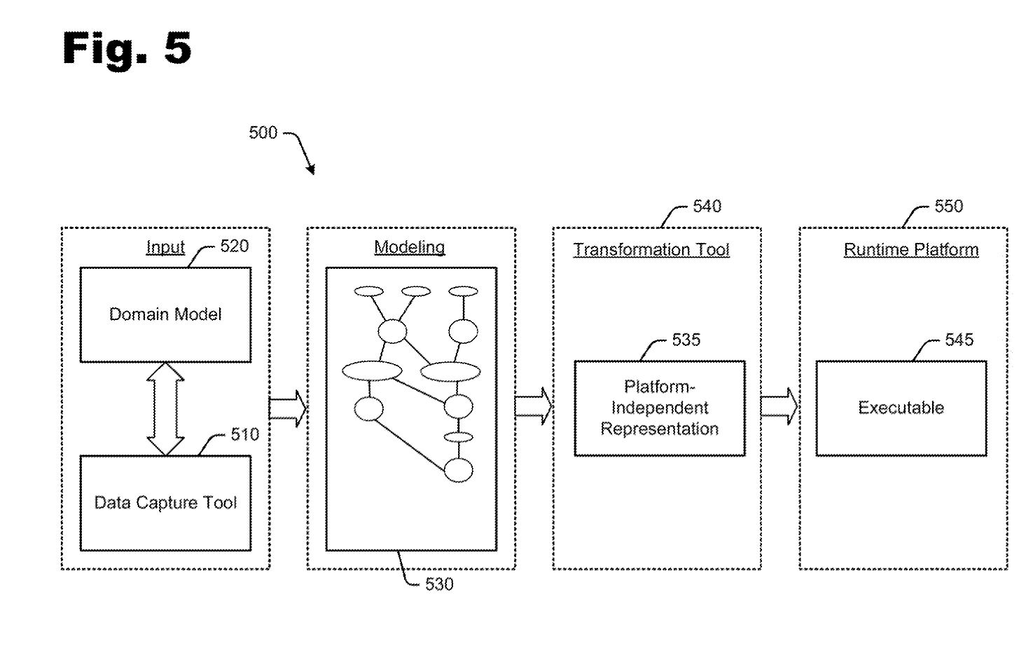

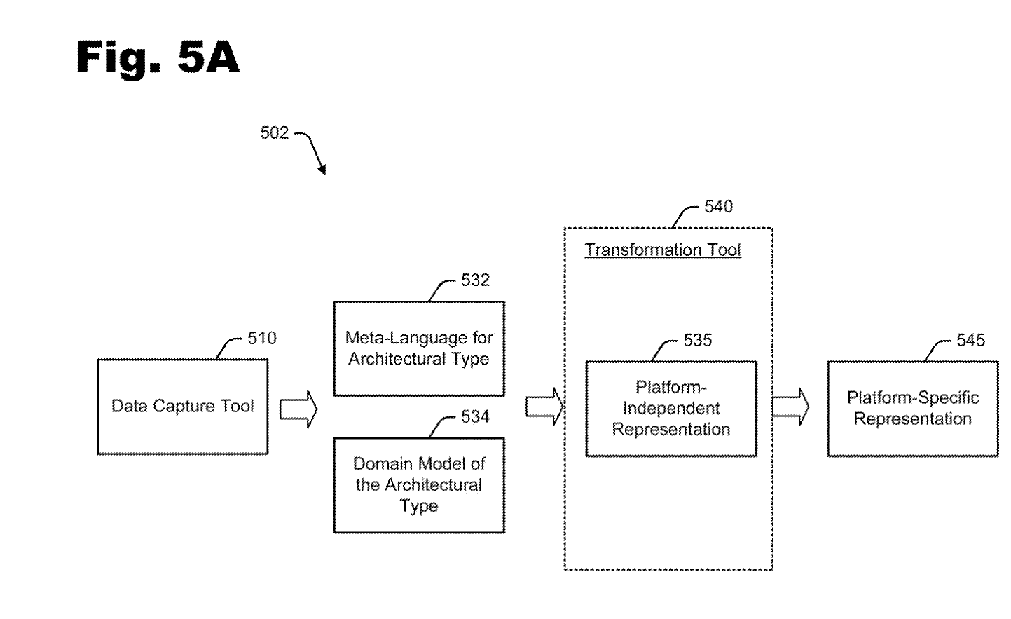

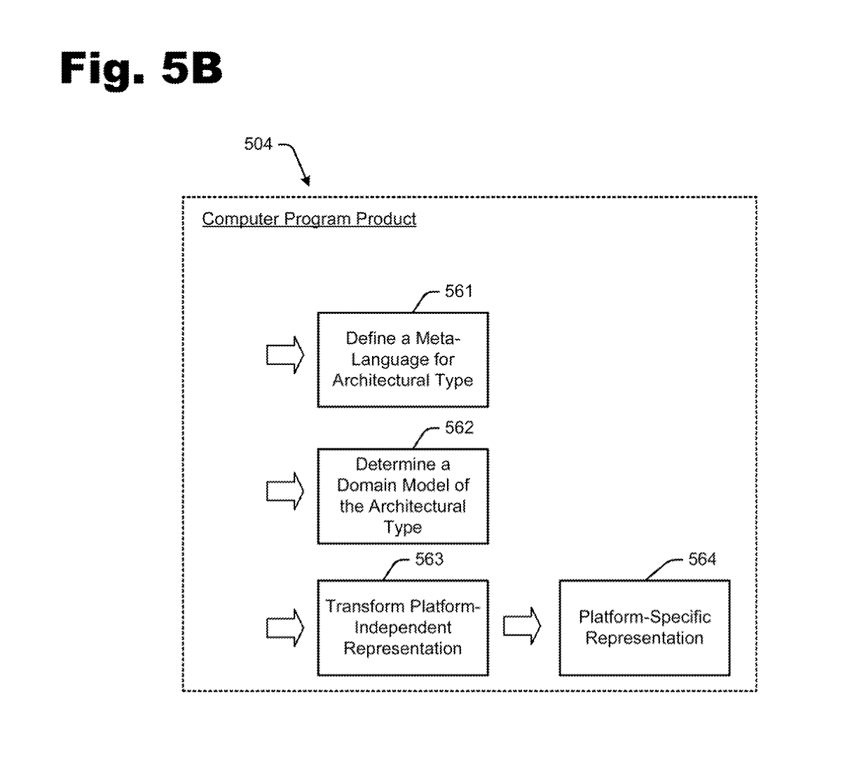

FIG. 5 is an illustration showing operation of an example tool chain 500 for service design to execution which may be implemented for specifying models of an architectural type. For purposes of illustration, the tool chain described with reference to FIG. 5 provides extract-transform-load capability from the domain model (e.g., RDA-based) to a Runtime Platform SCF).

In an example, the tool chain 500 may be implemented as a system having computer-readable instructions stored on non-transient computer-readable media and executable by a processor to specify models of an architectural type. In an example, the architectural type may be selected from Business Contextual Architecture (BCA), Conceptual Service Architecture (CSA), Logical Design Architecture (LDA), Physical Technology Architecture (PTA), Workflow Architecture, User Experience Architecture, and Orchestration Architecture.

In an example, the tool chain 500 may include a data capture tool 510 to define a domain model 520 of the architectural type. The data capture tool 510 defines a user interface (UI) meta-language for the architectural type. The data capture tool 510 also identifies object types and relationship types for the architectural type.

By way of illustration, QuickRDA is a lightweight, spreadsheet-based tool for capturing domain models. It includes data capture spreadsheets, diagram generation using GraphViz, and an API allowing model data to be exported for downstream uses such as reporting or configuration and code generation.

The data capture tool 510 may collect data in any suitable form, such as a generated diagram 530. It is noted that a “diagram” does not need to be generated prior to producing a platform-independent representation. In an example, if the data capture is visual, then the data capture, modeling, and diagram generation may be collapsed into a single step. In another example, if data capture is not visual, then two independent outputs may be generated, e.g., a) a diagram and/or b) a platform-independent representation.

Data may be exported to a platform-independent representation 535 of the domain model. The platform-independent representation 535 of the domain model may be an XML representation.

The platform independent-representation 535 may be input to a transformation tool 540 to undergo a transformation to a platform-specific representation for that architectural type.

In an example, the transformation tool 540 may be implemented to extract model data into XML format. The transformation tool transforms the XML file into configuration files. In an example, the platform-specific configuration files for schemas and schema transformations may be XSD and XSLT files deployed in the Integration Manager 423. In another example, the platform-specific configuration files for workflow and orchestration may be BPMN and BPEL files deployed in the orchestration manager (420 in FIG. 4).

The transformation tool 540 transforms the platform-independent representation 535 of the domain model 520 into an executable 545 (e.g., compiled code or configuration file) for a targeted runtime platform 550. In an example, the executable 545 may be deployed on an SCF runtime platform 550. The runtime platform 550 can process the executable 545 to enable the domain model 520.

The following Example illustrates application of the tool chain for model-driven integration for a simplified Human Resources scenario. In this example, the conceptual service architecture has three services: Work Force Administration (WFA), Payroll (PAY), and Health & Welfare Benefits (HWB). WFA owns fundamental objects Employee and OrgStructure. PAY owns fundamental objects BankAccount and DepositAllocation. HWB owns fundamental objects EligibilityOption and EnrollmentSelection.

In the Example, PAY and HWB subscribe to WFA's Employee object, and PAY subscribes to HWB's EnrollmentSelection object. Using the tool chain described herein, the configuration files can be automatically generated for deployment into the Integration Manager 430 in FIG. 4. This enables executing these publication and subscription flows for any particular service implementations of WFA, PAY, and HWB, along with the necessary routing, protocol and data transformations, and service invocations.

The above Example illustrates something much broader. In particular, the example demonstrates a generic methodology for pattern-based, model-driven tool chains. This approach eliminates the manual build phase for any solution space to which the methodology is applied, significantly reducing cost and implementation time, and dramatically increasing quality. These benefits come from treating solution designs as configuration data for application programs. The methodology can be applied to application modernization, as well as application development and maintenance, and fundamentally changes the way application products are developed.

FIG. 5A illustrates an example system to specify models of an architectural type. In an example, a system 502 has computer-readable instructions stored on non-transient computer-readable media and executable by a processor to specify models of an architectural type. The system includes a data capture tool 510 configured to define a meta-language 532 for an architectural type. The data capture tool 510 is further configured to define a domain model 534 of the architectural type and export a platform-independent representation 535 of the domain model. A transformation tool 540 is configured to transform the platform-independent representation 535 of the domain model into a platform-specific representation 545 of the domain model that is executable on a targeted runtime platform.

FIG. 5B illustrates an example computer program product 504 to specify models of an architectural type. In an example, the computer program product 504 is embodied as computer-readable instructions stored on non-transient computer-readable media and executable by a processor. When executed by the processor, the computer-readable instructions define 561 a meta-language for an architectural type. The computer-readable instructions also determine 562 a domain model of the architectural type. The computer-readable instructions also transform 563 a platform-independent representation of the domain model into a platform-specific representation 564 that is executable on a targeted runtime platform.

Before continuing, it should be noted that the examples described above are provided for purposes of illustration, and are not intended to be limiting. Other devices and/or device configurations may be utilized to carry out the operations described herein.

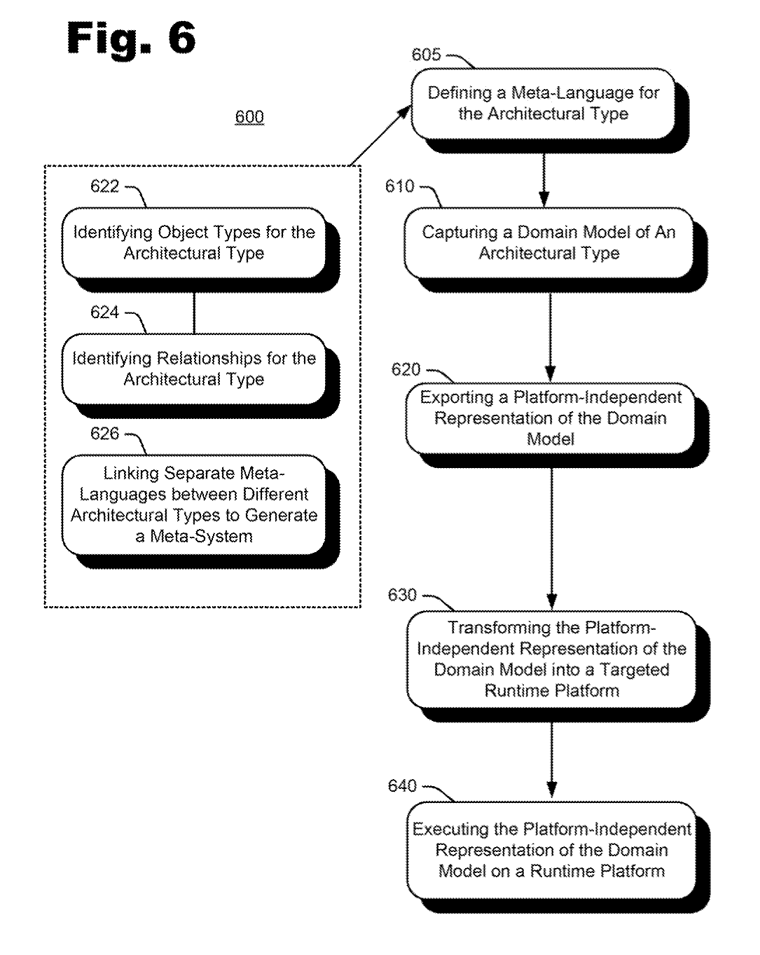

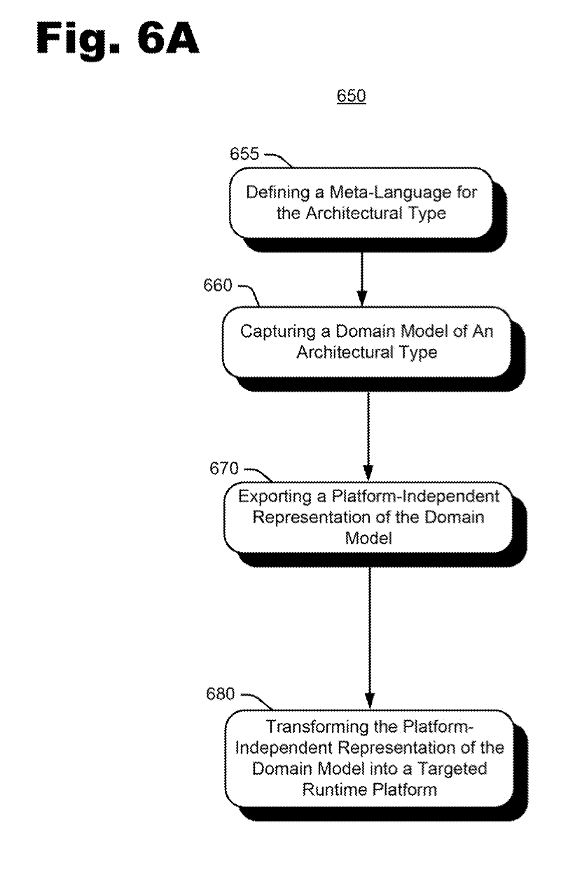

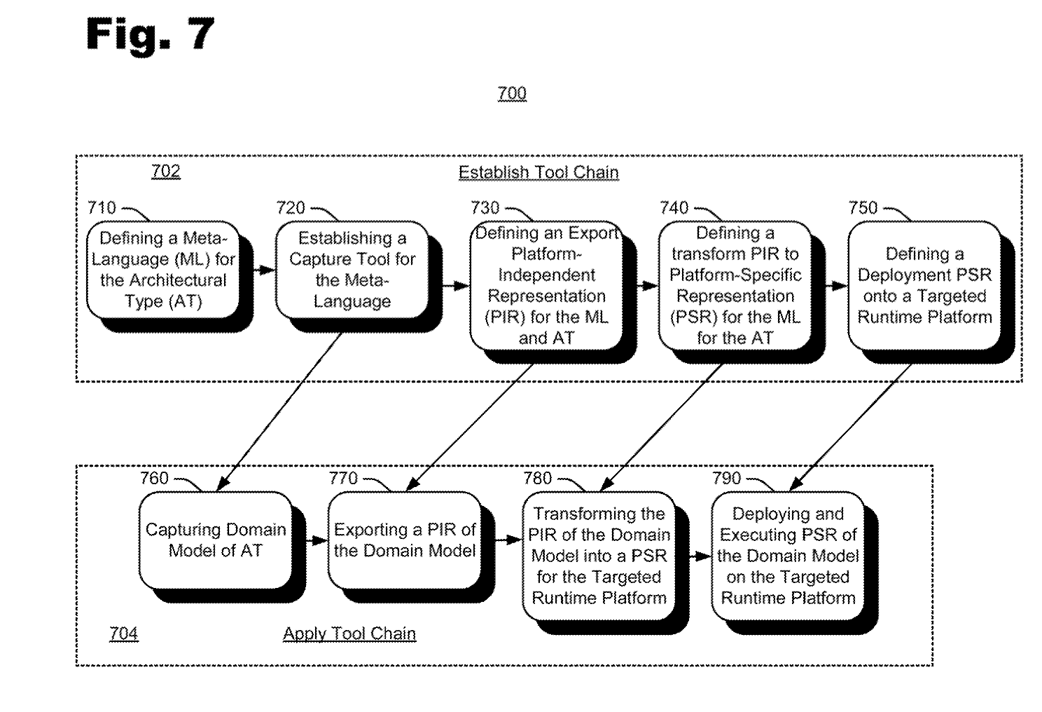

FIGS. 6, 6A, and 7 are flowcharts illustrating example operations which may be implemented for specifying models of an architectural type. Operations 600 (FIG. 6), 650 (FIG. 6A), and 700 (FIG. 7) may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

With reference to the operations 600 shown in FIG. 6, operation 605 includes defining a meta-language for the architectural type. An architectural type defines a class of problems. Examples of architectural types include business context architectures, conceptual services integration models, workflow models, composite user experience models, composite service orchestration models, relational database designs, and object oriented models. A meta-language for an architectural type specifies the formal terminology used to define a domain model of that architectural type. The meta-language for an architectural type identifies the objects and relationships between objects for that architectural type. The objects define the “nouns” of the architectural type and the relationships define the “verbs” of the architectural type. Consequently, in an example, operation 605 further includes operation 622 identifying object types for the architectural type. Examples of object types include role, responsibility, and artifact for business context architectures; conceptual service and fundamental object for conceptual services integration models; and user role, key user task, screen, and action for composite user experience models. In addition, operation 605 may further include operation 624 identifying relationship types for the architectural type. Examples of relationship types include responsibility “is assigned to” role, responsibility “provides” artifact, and responsibility “consumes” artifact for business context architectures; conceptual service “owns” fundamental object and conceptual service “subscribes to” fundamental object for conceptual services integration models; and user role “performs” key user task, key user task “has screen” screen, and screen “has action” action for composite user experience models.

Meta-languages can also include the terminology for linking different architectural types. Consequently, in an example, operation 605 may further include operation 626 linking separate meta-languages between different architectural types to generate a meta-system. A meta-system combines components of different architectural types. Examples of a meta-system include (a) a Role-based Domain Architecture 200 (in FIG. 2) which has components for Business Contextual, Conceptual Service, Logical Design, and Physical Technology architectural types; and (b) a Service Composition Framework 400 (in FIG. 4) which has components of User Experience, Orchestration, Integration, and Service Implementation architectural types.

Operation 610 includes capturing a domain model of an architectural type. Operation 620 includes exporting a platform-independent (e.g., XML) representation of the domain model. Operation 630 includes transforming the platform-independent representation of the domain model into a targeted runtime platform (e.g., a SCF Runtime Platform).

The operations shown and described herein are provided to illustrate example implementations. It is noted that the operations are not limited to the ordering shown. Still other operations may also be implemented.

In an example, further operations may include operation 640 executing the platform-independent representation of the domain model on a runtime platform. The runtime platform may include a custom code implementation of a composite service framework.

With reference to the operations 650 shown in FIG. 6A, operation 655 includes defining a meta-language for the architectural type. Operation 660 includes capturing a domain model of an architectural type. Operation 670 includes exporting a platform-independent representation of the domain model. Operation 680 includes transforming the platform-independent representation of the domain model into a targeted runtime platform.

With reference to FIG. 7, operations 700 may be considered first, for each architectural type, to establish a tool chain 702. Operation 710 includes defining a meta-language (ML) for the architectural type (AT). Operation 720 includes establishing a capture tool for the meta-language. Operation 730 includes defining an export platform-independent representation (PIR) for the ML and AT. Operation 740 includes defining a transform from the PIR to a platform-specific representation (PSR) for the ML for the AT. Operation 750 includes defining a deployment PSR onto a targeted runtime platform.

Operations 700 may also be considered to apply the tool chain to generate an executable solution 704. Operation 760 includes capturing a domain model of the AT. Operation 770 includes exporting a PIR of the domain model. Operation 780 includes transforming the PIR of the domain model into a PSR for the targeted runtime platform. Operation 790 includes deploying and executing the PSR of the domain model on the targeted runtime platform.

The operations may be implemented at least in part using an end-user interface (e.g., web-based interface). In an example, the end-user is able to make predetermined selections, and the operations described above are implemented on a back-end device to present results to a user. The user can then make further selections. It is also noted that various of the operations described herein may be automated or partially automated.

It is noted that the examples shown and described are provided for purposes of illustration and are not intended to be limiting. Still other examples are also contemplated.

1. A method stored as computer-readable instructions on non-transient computer-readable media and executable by a processor for specifying models of an architectural type, the method comprising:
defining a meta-language for the architectural type;
capturing a domain model of the architectural type;
exporting a platform-independent representation of the domain model; and
transforming the platform-independent representation of the domain model into a platform-specific representation of the domain model that is executable on a targeted runtime platform.

2. The method of claim 1, further comprising using a capture tool ha encodes the meta-language for the architectural type.

3. The method of claim 1, further comprising identifying object types of the meta-language for the architectural type.

4. The method of claim 1, further comprising identifying relationship types of the meta-language for the architectural type.

5. The method of claim 1, further comprising executing the platform-specific representation of the domain model on a runtime platform.

6. The method of claim 1, further comprising linking separate meta-languages for different architectural types to generate a meta-system.

7. The method of claim 6, wherein the meta-system is for a service composition solution.

8. The method of claim 1, wherein the architectural type is for a user centered design.

9. The method of claim 1, wherein the architectural type is selected from Business Contextual Architecture (BCA), Conceptual Service Architecture (GSA), Logical Design Architecture (LDA), Physical Technology Architecture (PTA), Workflow Architecture, User Experience Architecture, and Orchestration Architecture.

10. A system having computer-readable instructions stored on non-transient computer-readable media and executable by a processor to specify models of an architectural type, comprising:
a data capture tool to define a meta-language for an architectural type, the data capture tool to further define a domain model of the architectural type and export a platform-independent representation of the domain model; and
a transformation tool to transform the platform-independent representation of the domain model into a platform-specific representation of the domain model that is executable on a targeted runtime platform.

11. The system of claim 10, wherein the data capture tool further identifies object types and relationship types for the architectural type.

12. The system of claim 10, further comprising a custom code implementation of a service composition framework runtime platform to execute the platform-specific representation of the domain model.

13. The system of claim 10, wherein the transformation tool further implements a set of links between separate meta-languages for different architectural types to generate a meta-system.

14. A computer program product embodied as computer-readable instructions stored on non-transient computer-readable media and executable by a processor to:
define a meta-language for an architectural type;
determine a domain model of the architectural type; and
transform a platform-independent representation of the domain model into a platform-specific representation that is executable on a targeted runtime platform.

15. The computer program product of claim 14, wherein the architectural type is selected from Business Contextual Architecture (BCA), Conceptual Service Architecture (CSA), Logical Design Architecture (LDA), Physical Technology Architecture (PTA), Workflow Architecture, User Experience Architecture, and Orchestration Architecture.
